(19) United States
(12) Patent Application Publication
(10) Pub. No.: US 2026/0008077 A1
(43) Pub. Date: Jan. 8, 2026

(54) SHEET EMBELLISHING METHOD, SYSTEM, AND NON-TRANSITORY STORAGE MEDIUM

(71) Applicant: Duplo Corporation, Sagamihara-shi (JP)

(72) Inventor: Kazutaka Tsunoda, Sagamihara-shi (JP)

(73) Assignee: Duplo Corporation, Sagamihara-shi (JP)

(21) Appl. No.: 19/003,101

(22) Filed: Dec. 27, 2024

(30) Foreign Application Priority Data
Jul. 4, 2024 (JP) 2024-108263

(51) Int. Cl. B05D 3/06; B05D 5/00

(52) U.S. Cl. CPC B05D 3/067; B05D 5/00; B05D 2252/04; B05D 2501/00

(57) ABSTRACT

A sheet embellishing system that embellishes a sheet while conveying the sheet includes a varnish-applying device that applies varnish that is ultraviolet (UV) curable to the sheet, and irradiates the varnish by UV rays. The varnish-applying device performs half-curing of varnish applied to a first region of the sheet by irradiating the varnish applied to the first region by UV rays, and performs full-curing of varnish applied to a second region of the sheet by irradiating the varnish applied to the second region by UV rays under different irradiation conditions from the varnish applied to the first region, while the sheet is passed through the varnish-applying device once.

### BACKGROUND OF THE INVENTION

### 1. Field of the Invention

The present disclosure relates to a sheet embellishing method, a system, and a non-transitory storage medium.

### 2. Description of the Related Art

There is known technology in which a transfer material, such as foil or the like, is transferred to varnish applied to a surface of a sheet. There also is known technology in which a transfer web is brought into close contact with varnish applied to a surface of a sheet so as to transfer surface features of the transfer web to the varnish. Such technology is described in, for example, Japanese Unexamined Patent Application Publication No. 2021-167109.

### SUMMARY OF THE INVENTION

Conventionally, in a case in which varnish-coated regions that are only coated with varnish, and transfer regions in which transfer processing such as foil stamping is executed with respect to varnish, coexist on a surface of a sheet, the sheet is passed through a machine for coating, and further the sheet is passed through the machine for transfer processing, as well. That is to say, there is a need to pass the sheet through the machine twice.

Providing technology that enables embellishment of sheets in which varnish-coated regions and transfer regions coexist, by just one pass of the sheets through a machine, is desired. The present disclosure has been made in light of the foregoing circumstances.

A sheet embellishing method wherein a sheet is passed through a varnish-applying device, according to an aspect of the present disclosure includes
applying an ultraviolet (UV) curable varnish to a first region and a second region of a sheet, while conveying the sheet,
half-curing the varnish applied to the first region by irradiating the varnish applied to the first region by UV rays, and full-curing the varnish applied to the second region by irradiating the varnish applied to the second region by UV rays under different irradiation conditions from the varnish applied to the first region, while further conveying the sheet,
said applying of UV curable varnish, the half-curing, and full-curing being performed, while the sheet is passed through said varnish-applying device once.

It should be noted that optional combinations of the above components, and arrangements in which components and expressions of the present disclosure are interchanged among methods, devices, systems, and so forth, are also valid aspects of the present disclosure.

### BRIEF DESCRIPTION OF THE DRAWINGS

FIG. 1 is a side view schematically illustrating a sheet embellishing system according to an embodiment;

FIG. 2 is a top view schematically illustrating the sheet embellishing system according to the embodiment; and

FIG. 3 is a plan view of a varnish-applying device in FIG. 1.

### DESCRIPTION OF THE PREFERRED EMBODIMENTS

The present disclosure will be described below by way of a preferred embodiment, with reference to the drawings. The embodiment does not limit the disclosure but rather is exemplary, and not all features and combinations thereof described in the embodiment are necessarily essential to the disclosure. Components, members, and processing that are the same or equivalent in the drawings are denoted by the same symbols, and repetitive description will be omitted as appropriate.

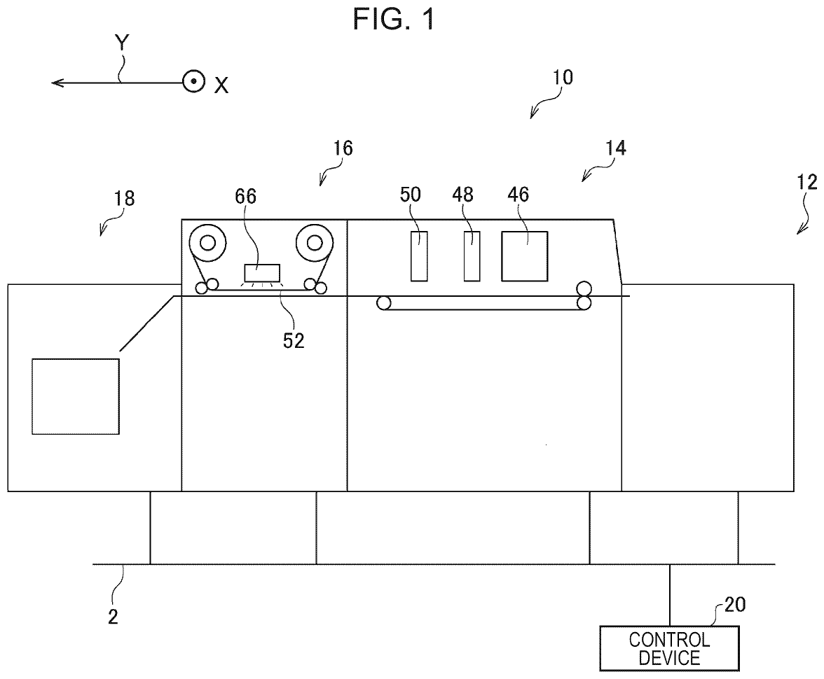

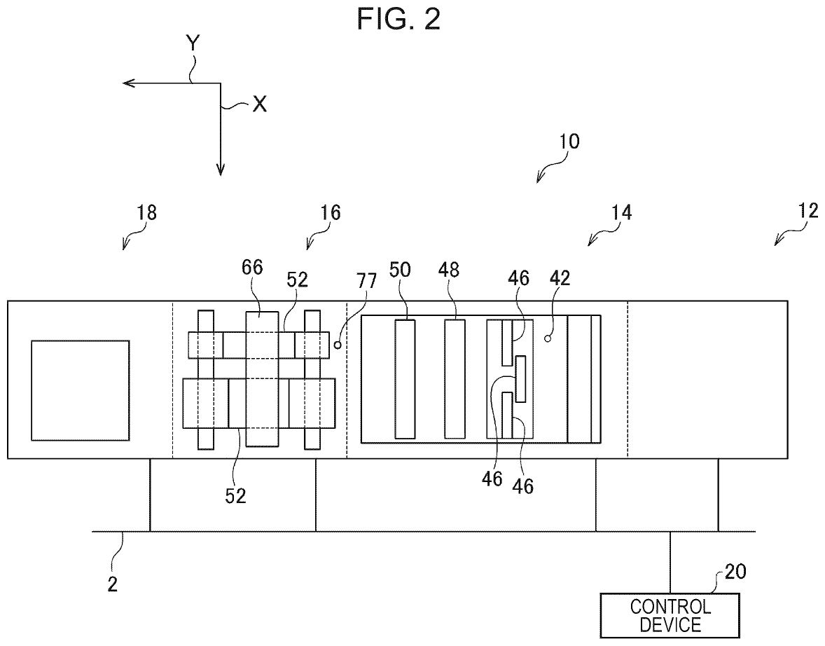

FIGS. 1 and 2 are diagrams that schematically illustrate a sheet embellishing system 10. FIG. 1 is a side view, and FIG. 2 is a plan view. The sheet embellishing system 10 is a system that performs predetermined embellishment of sheets while conveying the sheets. The sheets are made of various materials, such as paper, textile, resin, metal, and so forth.

Hereinafter, a direction in which sheets are conveyed (direction from right to left in FIGS. 1 and 2) will be referred to as a conveying direction Y, and a direction orthogonal to the conveying direction Y (direction orthogonal to the drawing in FIG. 1 and a top-bottom direction in FIG. 2) as a width direction X.

The sheet embellishing system 10 includes a sheet feeding device 12 that feeds sheets, one at a time, a varnish-applying device 14 that applies with an ultraviolet (UV) curable varnish (hereinafter, also referred to simply as “varnish”) to the sheets that are fed thereto one at a time, and irradiates the varnish by UV rays, a foil stamping device 16 that transfers foil onto the varnish that is applied to the sheet, taking advantage of tackiness of the varnish in a half-cured state, also known as foil stamping, a stacker 18 that stacks the sheets, and a control device 20 that centrally controls the sheet embellishing system 10. The sheet feeding device 12, the varnish-applying device 14, the foil stamping device 16, and the stacker 18 are arrayed in a single row in this order, from an upstream side (right side in FIGS. 1 and 2) toward a downstream side in the conveying direction Y. The control device 20 is connected to the sheet feeding device 12, the varnish-applying device 14, the foil stamping device 16, and the stacker 18, via a network 2.

In the present embodiment, the sheet embellishing system 10 is capable of executing a first mode (varnish coating mode) in which only varnish-coated regions are formed by one pass of a sheet through the sheet embellishing system 10, a second mode (transfer mode) in which only transfer (foil-stamped) regions are formed by one pass of a sheet therethrough, and a third mode (coexisting mode) in which both varnish-coated regions and transfer regions are formed by one pass of a sheet therethrough. Note, however, that it is sufficient for the sheet embellishing system 10 to be able to execute at least the third mode, and the sheet embellishing system 10 does not have to be capable of executing the first mode or the second mode. The control device 20 may accept selection of the mode to be executed from a user. Note that the second mode and the third mode can be understood as being a single mode. In this case, there may be a mode for forming transfer regions, and in this mode, the user may be able to select whether to form only transfer regions, or to form both varnish-coated regions and transfer regions.

The sheet feeding device 12 feeds sheets loaded on a sheet loading unit to the varnish-applying device 14, one at a time. A base image, and a plurality of registration marks that are references for identifying the position of the base image, are printed on the sheets by a unshown printing device that is located at a physically-separated location, for example.

The varnish-applying device 14 includes a sheet sensor 42, at least one (three in FIG. 2) varnish discharging portion 46, a first UV irradiation unit 48, and a second UV irradiation unit 50. The sheet sensor 42, the varnish discharging portion 46, the first UV irradiation unit 48, and the second UV irradiation unit 50 are provided in this order from the upstream side toward the downstream side. The count of the varnish discharging portions 46 is not limited in particular. The varnish-applying device 14 may include one varnish discharging portion 46 that extends over or beyond a range of the width direction X in which discharging of varnish is necessary, or may include two or four or more varnish discharging portions 46.

The sheet sensor 42 detects sheets fed from the sheet feeding device 12.

The varnish discharging portion 46 is a line inkjet head, although not limited thereto in particular. Under control of the control device 20, the varnish discharging portion 46 discharges varnish in accordance with varnish discharge data, triggered by detection of a sheet by the sheet sensor 42, and thereby applies varnish to the sheet. The varnish discharge data is data indicating regions of the sheet to which varnish is to be applied (hereinafter referred to as “varnish-application region”). The varnish-application region may have a predetermined relation with the base image.

The first UV irradiation unit 48 and the second UV irradiation unit 50 emit UV rays under control of the control device 20.

In the first mode, all varnish that is applied to the sheet is full-cured. Full-curing is to completely cure the varnish. The varnish may be irradiated by UV rays from the first UV irradiation unit 48 alone, the varnish may be irradiated by UV rays from the second UV irradiation unit 50 alone, or the varnish may be irradiated by UV rays from both the first UV irradiation unit 48 and the second UV irradiation unit 50, but in any case, all varnish that is applied to the sheet is full-cured. In the first mode, there is no foil-stamping at the foil stamping device 16 downstream. Accordingly, a foil-stamping UV irradiation unit 66 of the hot stamping device 16 is preferably set to off.

In the second mode, all varnish that is applied to the sheet is half-cured. Half-curing is curing to a degree in which fluidity of the varnish is reduced, but the varnish is not completely cured, and can be further cured therefrom, for example. Varnish in a half-cured state has tackiness. The varnish may be irradiated by UV rays from the first UV irradiation unit 48 alone, the varnish may be irradiated by UV rays from the second UV irradiation unit 50 alone, or the varnish may be irradiated by UV rays from both the first UV irradiation unit 48 and the second UV irradiation unit 50, but in any case, all varnish applied to the sheet is half-cured. The half-cured varnish is subjected to hot stamping, and also is full-cured, by the foil stamping device 16 downstream.

In the third mode, the varnish-application regions include first regions and second regions. The first regions are regions on the surface of the sheet that will be subjected to hot stamping by the foil stamping device 16 downstream. The second regions are regions on the surface of the sheet that will only be coated with varnish and will not be subjected to foil stamping. Passing the sheet through the varnish-applying device 14 applies varnish to the sheet in both the first regions and the second regions.

The varnish-application regions may be sectioned into the first regions and the second regions by the user, via the control device 20 for example. The control device 20 may, for example, display, on a predetermined display unit, an image indicating varnish-application regions on the basis of varnish discharge data, with the user sectioning the varnish-application regions in the image into the first regions and the second regions. Alternatively, the varnish-application regions may be sectioned into the first regions and the second regions by sectioning data included in the job. The sectioning data may be included in the varnish discharge data.

The first UV irradiation unit 48 irradiates the varnish applied to the first regions of the sheet (hereinafter also referred to as “first-region varnish”) by UV rays, and thereby performs half-curing of the first-region varnish. The half-cured varnish is subjected to foil stamping by the foil stamping device 16, and is also full-cured. The second UV irradiation unit 50 irradiates the varnish applied to the second regions of the sheet (hereinafter also referred to as “second-region varnish”) by UV rays, and thereby performs full-curing of the second-region varnish.

Note that the first UV irradiation unit 48 may irradiate the second-region varnish as well as the first-region varnish with UV rays, and perform half-curing of the second-region varnish as well as the first-region varnish. That is to say, the second-region varnish may be half-cured before being full-cured. In this case, the second-region varnish can be suppressed from bleeding and spreading in a planar direction of the sheet before full-curing, and accordingly shapes of the second-region varnish in the planar direction of the sheet are stabilized.

In the first mode, the foil stamping device 16 conveys the sheets to the stacker 18 without change. That is to say, in the first mode, foil stamping by the foil stamping device 16 is not performed.

In the second mode and the third mode, the foil stamping device 16 conveys the sheets, and also conveys a web (transfer web) 52 by roll-to-roll, and transfers the foil held by the web 52 to the sheet, i.e., performs foil stamping. The web 52 is a foil-holding film that holds foil (e.g., metal foil) on a film (base sheet). The foil stamping device 16 uses the tackiness of the varnish in the half-cured state to cause the foil held by the web 52 to adhere to the varnish. In a state in which the foil is adhering to the varnish in a half-cured state and also is held by the web 52, the varnish in the half-cured state is irradiated by UV rays by the foil-stamping UV irradiation unit 66, thereby performing full-curing of the varnish. Once the varnish is full-cured, the force of the foil adhering to the varnish is greater than the force of the web 52 holding the foil. Separating the web 52 from the sheet in this state transfers the foil that was held by the web 52 to the varnish.

The stacker 18 stacks sheets (embellished sheets) that are carried out from the foil stamping device 16.

The control device 20 controls operations of the sheet embellishing system 10 in general. From a hardware perspective, the control device 20 can be realized by elements and mechanical devices such as a processor like a central processing unit (CPU) or the like, and memory such as read-only memory (ROM), random access memory (RAM), and so forth, of a computer. From a software perspective, the control device 20 can be realized by computer programs and so forth. Those skilled in the art will appreciate that the control device 20 can be realized in various forms by combining hardware and software.

The control device 20 accepts input regarding definitions of printing jobs. The control device 20 may display a predetermined job management screen, and accept input of definitions of jobs. Definitions of jobs can include a count of sheets to be subjected to embellishment (count of embellished prints), size of sheets to be subjected to embellishment, varnish discharge data, and mode to be executed, for example. The control device 20 controls the sheet feeding device 12, the varnish-applying device 14, and the foil stamping device 16, on the basis of the definitions of jobs.

The processor executes a program stored in the memory, for example, whereby the control device 20 controls operations of the various devices of the sheet embellishing system 10 in accordance with the program. The processor may execute a program stored in a storage device, may execute a program acquired from a recording medium by a reading device, and may execute a program acquired by a communication interface via a network.

The program that the control device 20 executes is capable of executing the first mode, the second mode, and the third mode. Note, however, that it is sufficient for the program to be able to execute at least the third mode, and the program does not have to be capable of executing the first mode or the second mode. For example, a program stored in a storage device in advance may be capable of executing the third mode. Alternatively, a program that is capable of executing the third mode may be stored in the storage device afterwards. For example, the program stored in the storage device in advance may be capable of executing the first mode or the second mode, and an add-on a program that is capable of executing the third mode may be stored in the storage device afterwards.

This so far is a basic configuration of the sheet embellishing system 10.

As a modification, the sheet embellishing system 10 may be equipped with a printing device that prints images on sheets, and feeds the sheets one at a time to the varnish-applying device 14, instead of the sheet feeding device 12.

Also, the sheet embellishing system 10 may be equipped with another device interposed between the foil stamping device 16 and the stacker 18. The other device is a post-processing device that cuts or binds sheets, a separate applying device for protecting the surface of the foil with varnish, an interleaf inserter for surface protection, or a puncher for punching sheets into predetermined shapes to create carton materials or the like, for example.

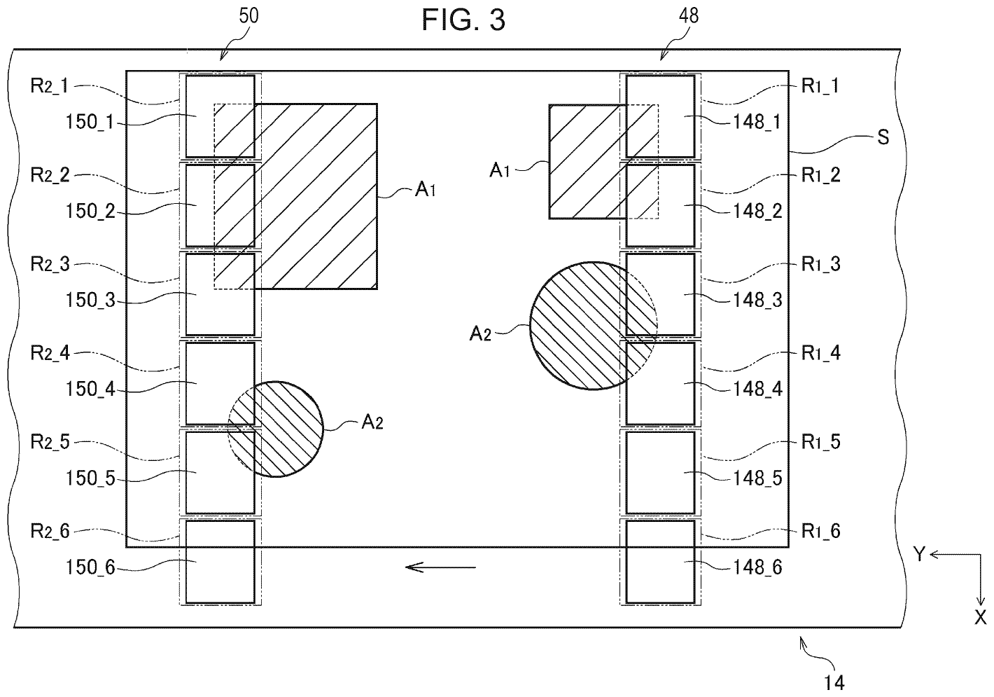

Next, the UV irradiation units 48 and 50 of the varnish-applying device 14 will be described in detail. FIG. 3 is a plan view of the varnish-applying device 14. The varnish-applying device 14 is currently conveying a sheet S. In this example, the varnish-applying device 14 is operating in the third mode. Varnish is applied to first regions A₁ and the second regions A₂ of the sheet S by the varnish discharging portion 46.

The first UV irradiation unit 48 includes six, i.e., a plurality of first irradiation units 148. Note that the count of first irradiation units 148 is not limited in particular.

The plurality of first irradiation units 148 are disposed at different positions from each other in the width direction X. In the example that is illustrated, the plurality of first irradiation units 148 are arrayed in one row in the width direction X.

UV emission intensity of UV emission by the plurality of first irradiation units 148 can be individually controlled. The term “UV emission intensity can be individually controlled” as used here is not limited to a capability of individually increasing or reducing the UV emission intensity, and also includes individually setting the UV emission intensity to zero, i.e., individually turning on/off.

Each of the plurality of first irradiation units 148 includes one or a plurality of UV light sources. The UV light sources typically are light-emitting diodes (LEDs), but may be other light sources, such as light bulbs, fluorescent lamps, or the like, as long as they are light sources that emit UV rays.

In the third mode, first irradiation units 148_i (i=1, 2, and so forth through 6) emit UV rays while the first regions A₁ are passing through irradiation ranges R₁_i thereof, such that the varnish of the first regions A₁ is half-cured. In the example that is illustrated, the first region A₁ is passing through irradiation ranges R₁_1 and R₁_2, and accordingly first irradiation units 148_1 and 148_2 are emitting UV rays.

Note that in the third mode, the first irradiation units 148_i may emit UV rays while the second regions A₂ are passing the irradiation ranges R₁_i thereof and perform half-curing of the varnish of the second regions A₂. In the example that is illustrated, the second region A₂ is passing through irradiation ranges R₁_3 and R₁_4, and accordingly first irradiation units 148_3 and 148_4 may emit UV rays. In this case, the first irradiation units 148_i may continue to emit UV rays while the sheet is passing. Note, however, that by the first irradiation unit 148_i emitting UV rays only while the first regions A₁ or the second regions A₂ are passing the irradiation ranges R₁_i thereof, energy that is necessary for emitting UV rays can be reduced, and further, deterioration and so forth of the sheet due to being irradiated by UV rays in regions on the surface of the sheet to which varnish is not applied can be suppressed.

The second UV irradiation unit 50 includes six, i.e., a plurality of second irradiation units 150. Note that the count of the second irradiation units 150 is not limited in particular.

The count of the first irradiation units 148 and the count of the second irradiation units 150 may be the same, as in the example that is illustrated, or may be different. For example, the count of the second irradiation units 150 may be greater than the count of the first irradiation units 148.

The plurality of second irradiation units 150 are disposed at different positions from each other in the width direction X. In the example that is illustrated, the plurality of second irradiation units 150 are arrayed in one row in the width direction X.

UV emission intensity of UV emission by the plurality of second irradiation units 150 can be individually controlled. Each of the plurality of second irradiation units 150 includes one or a plurality of UV light sources.

In the third mode, second irradiation units 150_i (i=1, 2, and so forth through 6) emit UV rays while the second regions A₂ are passing through irradiation ranges R₂_i thereof, such that the varnish in the second regions A₂ is full-cured. In the example that is illustrated, the second region A₂ is passing through irradiation ranges R₂_4 and R₂_5, and accordingly second irradiation units 150_4 and 150_5 are emitting UV rays.

On the other hand, in the third mode, the second irradiation units 150_i (i=1, 2, and so forth through 6) do not emit UV rays while the first regions A₁ are passing through the irradiation ranges R₂_i thereof. In the example that is illustrated, the first region A₁ is passing through irradiation ranges R₂_1, R₂_2, and R₂_3, and accordingly second irradiation units 150_1, 150_2, and 150_3 do not emit UV rays. Thus, full-curing of the varnish of the first region A₁ can be averted.

However, when both a first region A₁ and a second region A₂ enter one irradiation range R₂_i at the same time, selective full-curing of just the second region A₂ cannot be performed. Accordingly, the positions of the plurality of second irradiation units 150 may be changeable in the width direction X, either manually, or automatically by a moving mechanism that is not illustrated. Thus, there will be cases in which adjustment can be performed such that both a first region A₁ and a second region A₂ do not enter a given irradiation range R₂_i at the same time. In other words, more layouts of first regions A₁ and second regions A₂ can be made in which the first regions A₁ are half-cured and the second regions A₂ alone are selectively full-cured, resulting in a higher degree of freedom in design relating to embellishment of sheets.

Note that the positions of the plurality of first irradiation units 148 may also be changeable in the width direction X, either manually, or automatically by a moving mechanism that is not illustrated.

Now, when total light intensity (J/cm²) of UV rays with which varnish of the first region A₁ is irradiated is excessively great, the varnish of the first region A₁ is full-cured, while when total light intensity of UV rays with which varnish of the first region A₁ is irradiated is insufficient, the varnish of the first region A₁ cannot be half-cured. When total light intensity of UV rays with which varnish of the second region A₂ is irradiated is insufficient, the varnish of the second region A₂ cannot be full-cured.

The greater the UV intensity of UV rays by which the varnish is irradiated is, and the longer the time of the varnish being irradiated by UV rays is, the greater the total light intensity of the UV rays is. Also, the smaller the UV intensity of UV rays by which the varnish is irradiated is, and the shorter the time of the varnish being irradiated by UV rays is, the smaller the total light intensity of the UV rays is.

Accordingly, there is a need to appropriately decide irradiation conditions of UV rays, which are conditions that affect the total light intensity. The irradiation conditions of UV rays include at least UV emission intensity, UV emission distance, and sheet conveying speed.

The “UV emission intensity” is the UV intensity of UV rays emitted from the UV irradiation units 48 and 50. The greater the UV emission intensity is, the greater the UV intensity of UV rays by which the varnish is irradiated is, and the smaller the UV emission intensity is, the smaller the UV intensity of UV rays by which the varnish is irradiated is.

The “UV emission distance” is the distance (height) from the UV irradiation units 48 and 50 to the sheet facing the UV irradiation units 48 and 50. The shorter the UV emission distance is, the greater the UV intensity of UV rays by which the varnish is irradiated is, and the longer the UV emission distance is, the smaller the UV intensity of UV rays by which the varnish is irradiated is. Also, the UV rays emitted from the UV irradiation units 48 and 50 spread as they travel, and accordingly the longer the UV emission distance is, the broader the irradiation ranges that are irradiated by the UV rays emitted from the UV irradiation units 48 and 50 (hereinafter referred to as “irradiation ranges of UV irradiation units 48 and 50”) are. That is to say, the irradiation ranges of the UV irradiation units 48 and 50 become longer in the conveying direction Y. Accordingly, the longer the UV emission distance is, the longer an irradiation time of UV rays regarding a point that is on the sheet being conveyed at a predetermined conveying speed and that passes through the irradiation ranges of the UV irradiation units 48 and 50 is. On the other hand, the shorter the UV emission distance is, the narrower the irradiation ranges of the UV irradiation units 48 and 50 are. That is to say, the irradiation ranges of the UV irradiation units 48 and 50 become shorter in the conveying direction Y. Accordingly, the shorter the UV emission distance is, the shorter the irradiation time of UV rays regarding a point that is on the sheet being conveyed at a predetermined conveying speed and that passes through the irradiation ranges of the UV irradiation units 48 and 50 is. The “sheet conveying speed” is the conveying speed of conveying the sheet. The lower the sheet conveying speed is, the longer the irradiation time of irradiation by UV rays is, and the higher the sheet conveying speed is, the shorter the irradiation time of irradiation by UV rays is.

The user can decide the irradiation conditions for the varnish of the first regions A₁ and the varnish of the second regions A₂ in the third mode, on the basis of testing and simulation. Note that the varnish of the second regions A₂ that is to be full-cured requires a greater total light intensity as compared to the varnish of the first regions A₁ that is to be half-cured, and accordingly the irradiation conditions for the varnish of the second regions A₂ are different from the irradiation conditions for the varnish of the first regions A₁, as a matter of course.

Next, advantageous effects of the present embodiment will be described. According to the present embodiment varnish applied to the first regions A₁ on the surface of a sheet can be half-cured, and varnish applied to the second regions A₂ can be full-cured, by just one pass of the sheet through the varnish-applying device 14. Thus, according to the present embodiment, the first regions A₁ on the surface of the sheet can be foil stamped, and the second regions A₂ can be varnish-coated, by just one pass of the sheet through the sheet embellishing system 10.

Also, according to the present embodiment, the first regions A are varnish-coated and foil-stamped thereupon, and the second regions A₂ are just varnish-coated with no adhesion of foil, by just one pass of a sheet through the sheet embellishing system 10. Conventionally there is a need to pass the sheet twice through the machine to obtain the same embellishment. More particularly, at the first time, varnish is applied to the second regions A₂, or to both the first regions A₁ and the second regions A₂, which is full-cured, and at the second time, varnish is applied to the first regions A₁ and half-cured, and foil stamping is performed on the varnish and also the varnish is full-cured. In this case, completely eliminating positional deviation between application positions of varnish the first time and application positions of varnish the second time is difficult. Conversely, according to the present embodiment only one application of varnish is necessary, the problem of deviation in application positions of varnish such as in conventional technology does not arise. Also, trouble and time for embellishment of sheets, and hence costs, can be reduced as compared to the conventional technology in which there is a need to pass the sheet through the machine twice.

The present disclosure has been described above by way of an embodiment. This embodiment is exemplary, and those skilled in the art will appreciate that various modifications can be made by combining the components and processing processes thereof, and that such modifications are also encompassed by the scope of the present disclosure. Such modifications will be described below.

### Modification 1

In a case in which, during the entire length of the sheet passing through the irradiation range R₁_i of the first irradiation unit 148_i, only first regions A₁ pass through this irradiation range R₁_i, the first irradiation unit 148_i may continue emitting UV rays as long as the sheet is passing through the irradiation range R₁_i, or as long as the job is being executed, for example. Note that in a case in which, during the entire length of the sheet passing through the irradiation range R₁_i of the first irradiation unit 148_i, at least one of first regions A₁ and second regions A₂ passes through this irradiation range R₁_i, the first irradiation unit 148_i may continue emitting the UV rays as long as the sheet is passing through the irradiation range R₁_i, or as long as the job is being executed, for example.

In a case in which, during the entire length of the sheet passing through the irradiation range R₂_i of the second irradiation unit 150_i, only second regions A₂ pass through this irradiation range R₂_i, the second irradiation unit 150_i may continue emitting UV rays as long as the sheet is passing through the irradiation range R₂_i, or as long as the job is being executed, for example.

As an application of this, in a case in which first regions A₁ are present only on one side of a certain position as a boundary in the width direction X of the sheet, and second regions A₂ are present only on other side, i.e., in a case in which transfer (foil stamping) regions are formed only on one side, and varnish-coated regions are formed only on the other side, the following may be performed with that certain position as a boundary. (1) The first irradiation units 148 situated on one side continue emitting UV rays, (2) the first irradiation units 148 situated on the other side do not emit UV rays, (3) the second irradiation units 150 situated on the one side do not emit UV rays, and (4) the second irradiation units 150 situated on the other side continue emitting UV rays.

The foil-stamping UV irradiation unit 66 of the foil stamping device 16 may include a plurality of irradiation units that are disposed at different positions in the width direction, in the same way as the UV irradiation units 48 and 50 of the varnish-applying device 14. In this case, out of the plurality of irradiation units of the foil-stamping UV irradiation unit 66, the irradiation units situated on one side from a certain position on the sheet may continue emitting UV rays, and the irradiation units situated on the other side do not have to emit UV rays.

Thus, in a case in which first regions A₁ are present only on one side of a certain position as a boundary in the width direction X of the sheet, and second regions A₂ are present only on other side, detailed control of emission timings of the irradiation units of the UV irradiation units becomes unnecessary.

### Modification 2

Although in the embodiment and the above-described modification, the varnish-applying device 14 has the two UV irradiation units 48 and 50, but the varnish-applying device 14 may have just one UV irradiation unit. For example, the varnish-applying device 14 may have just the second UV irradiation unit 50 without having the first UV irradiation unit 48. In this case, each of the second irradiation units 150_i emits UV rays of a UV emission intensity for half-curing while the first regions A₁ are passing through the irradiation range R₂_i thereof, and thus performs half-curing of the varnish of the first regions A₁, and emits UV rays of a UV emission intensity for full-curing, which is a UV emission intensity that is stronger than the UV emission intensity for half-curing, while the second regions A₂ are passing through the irradiation range R₂_i thereof, and thus performs full-curing of the varnish of the second regions A₂.

For example, in the example in FIG. 3, the first region A₁ is passing through the irradiation ranges R₂_1, R₂_2, and R₂_3, and accordingly the second irradiation units 150_1, 150_2, and 150_3 emit UV rays of a UV emission intensity for half-curing. Also, the second region A₂ is passing through the irradiation ranges R₂_4 and R₂_5, and accordingly the second irradiation units 150_4 and 150_5 emit UV rays of a UV emission intensity for full-curing.

According to the present embodiment advantageous effects that are the same as those of the embodiment can be yielded.

### Modification 3

Unlike the embodiment and above-described modifications, the irradiation units of the UV irradiation units 48 and 50 may be configured to be capable of scanning UV rays in the width direction X, using known technology. For example, the irradiation units of the UV irradiation units 48 and 50 may be configured to be capable of scanning UV rays in the width direction X, using technology that is the same as technology for scanning exposure light in a laser printer. In this case, the UV irradiation units 48 and 50 can emit UV rays to the entire range in the width direction X by a single irradiation unit, for example.

### Modification 4

Although not mentioned in particular in the embodiment, thickness of varnish affects full-curing and half-curing of the varnish. Accordingly, irradiation conditions may be adjusted taking the thickness of the varnish into consideration. For example, UV rays of a higher UV intensity may be emitted the thicker the varnish is, and UV rays of a lower UV intensity may be emitted the thinner the varnish is.

### Modification 5

Although description has been made in the embodiment and above-described modifications regarding cases of foil stamping the half-cured varnish, i.e., cases of performing foil stamping as transfer processing, this is not restrictive, and other transfer processing may be executed regarding half-cured varnish. For example, a transfer device may be provided that executes transfer processing, by which a web with fine asperities formed on the surface thereof being brought into contact with the half-cured varnish, so as to transfer the fine asperities to the varnish, instead of the foil stamping device 16.

Optional combinations of the above-described embodiment and modifications are also useful as embodiments of the present disclosure. New embodiments created by combinations have the respective advantages of the embodiment and modifications that are combined.

What is claimed is:

1. A sheet embellishing method wherein a sheet is passed through a varnish-applying device, said method comprising:
applying an ultraviolet (UV) curable varnish to a first region and a second region of a sheet, while conveying the sheet;
half-curing the varnish applied to the first region by irradiating the varnish applied to the first region by UV rays, and full-curing the varnish applied to the second region by irradiating the varnish applied to the second region by UV rays under different irradiation conditions from the varnish applied to the first region, while further conveying the sheet;
said applying of UV curable varnish, half-curing, and full-curing being performed while the sheet is passed through said varnish-applying device once.

2. The sheet embellishing method according to claim 1, wherein
the varnish-applying device includes a first UV irradiation unit and a second UV irradiation unit,
in the half-curing, half-curing of the varnish applied to the first region is performed by the first UV irradiation unit irradiating only the varnish applied to the first region by UV rays, and
in the full-curing, full-curing of the varnish applied to the second region is performed by the second UV irradiation unit irradiating only the varnish applied to the second region by UV rays.

3. The sheet embellishing method according to claim 1, wherein
the varnish-applying device includes a first UV irradiation unit and a second UV irradiation unit,
in the half-curing, half-curing of the varnish applied to the first region is performed by the first UV irradiation unit irradiating the varnish applied to the first region by UV rays, and
in the full-curing, full-curing of the varnish applied to the second region is performed by the first UV irradiation unit irradiating the varnish applied to the second region by UV rays, and the second UV irradiation unit further irradiating only the varnish applied to the second region by UV rays.

4. The sheet embellishing method according to claim 1, wherein
the varnish-applying device includes a first UV irradiation unit and a second UV irradiation unit,
the first UV irradiation unit includes a plurality of first irradiation units that are disposed at positions that are different from each other in a width direction, and regarding which UV emission intensity is individually controllable,
the second UV irradiation unit includes a plurality of second irradiation units that are disposed at positions that are different from each other in a width direction, and regarding which UV emission intensity is individually controllable,
in the half-curing, half-curing of the varnish applied to the first region is performed by each of the plurality of first irradiation units emitting UV rays while the first region is passing through an irradiation range thereof, and
in the full-curing, full-curing of the varnish applied to the second region is performed by each of the plurality of second irradiation units emitting UV rays while the second region is passing through an irradiation range thereof.

5. The sheet embellishing method according to claim 1, wherein
the varnish-applying device includes a first UV irradiation unit and a second UV irradiation unit,
the first UV irradiation unit includes a plurality of first irradiation units that are disposed at positions that are different from each other in a width direction, and regarding which UV emission intensity is individually controllable,
the second UV irradiation unit that is disposed on a downstream side of the first UV irradiation unit includes a plurality of second irradiation units that are disposed at positions that are different from each other in a width direction, and regarding which UV emission intensity is individually controllable,
in the half-curing, half-curing of the varnish applied to the first region is performed by each of the plurality of first irradiation units emitting UV rays while the first region is passing through an irradiation range thereof, and
in the full-curing, full-curing of the varnish applied to the second region is performed by each of the plurality of first irradiation units emitting UV rays while the second region is passing through an irradiation range thereof, and further, each of the plurality of second irradiation units emitting UV rays while the second region is passing through an irradiation range thereof.

6. The sheet embellishing method according to claim 1, wherein
the varnish-applying device includes a plurality of irradiation units that are disposed at positions that are different from each other in a width direction, and regarding which UV emission intensity is individually controllable,
in the half-curing, half-curing of the varnish applied to the first region is performed by each of the plurality of irradiation units emitting UV rays while the first region is passing through an irradiation range thereof, and
in the full-curing, full-curing of the varnish applied to the second region is performed by each of the plurality of irradiation units irradiating the varnish applied to the second region by UV rays while the second region is passing through an irradiation range thereof, under different irradiation conditions from while the first region is passing therethrough.

7. The sheet embellishing method according to claim 1, wherein
transferring, in which varnish that is applied to the second region and half-cured is subjected to predetermined transfer processing, is further performed following the half-curing, while the sheet is passed through the varnish-applying device once.

8. A sheet embellishing system that embellishes a sheet, the system comprising:
a conveying unit that conveys the sheet;
a varnish-applying device that applies varnish that is ultraviolet (UV) curable to the sheet during conveying by the conveying unit, and irradiates the varnish by UV rays; and
a control unit that controls the varnish-applying device to
apply varnish to a first region and a second region of the sheet,
perform half-curing of the varnish applied to the first region by irradiating the varnish applied to the first region by UV rays, and
perform full-curing of the varnish applied to the second region by irradiating the varnish applied to the second region by UV rays under different irradiation conditions from the varnish applied to the first region,
while the sheet is passed through the varnish-applying device once.

9. The sheet embellishing system according to claim 8, wherein
the varnish-applying device includes a first UV irradiation unit and a second UV irradiation unit,
the control unit controls
the first UV irradiation unit to perform half-curing of the varnish applied to the first region by irradiating only the varnish applied to the first region by UV rays, or to perform half-curing of both of the varnish applied to the first region and the varnish applied to the second region by irradiating both the varnish applied to the first region and the varnish applied to the second region by UV rays, and
the second UV irradiation unit to perform full-curing of the varnish applied to the second region by irradiating only the varnish applied to the second region by UV rays.

10. The sheet embellishing system according to claim 8, wherein
the varnish-applying device includes a first UV irradiation unit and a second UV irradiation unit,
the first UV irradiation unit includes a plurality of first irradiation units that are disposed at positions that are different from each other in a width direction, and regarding which UV emission intensity is individually controllable,
the second UV irradiation unit includes a plurality of second irradiation units that are disposed at positions that are different from each other in a width direction, and regarding which UV emission intensity is individually controllable, and
the control unit controls
each of the plurality of first irradiation units to perform half-curing of the varnish applied to the first region by emitting UV rays while the first region is passing through an irradiation range thereof, and
each of the plurality of second irradiation units to perform full-curing of the varnish applied to the second region by emitting UV rays while the second region is passing through an irradiation range thereof.

11. The sheet embellishing system according to claim 10, wherein
the first UV irradiation unit is disposed on an upstream side of the second UV irradiation unit, and
the control unit causes each of the plurality of first irradiation units to perform half-curing of the varnish applied to the second region by emitting UV rays while the second region is passing through an irradiation range thereof.

12. The sheet embellishing system according to claim 8, wherein
the varnish-applying device includes a plurality of irradiation units that are disposed at positions that are different from each other in a width direction, and regarding which UV emission intensity is individually controllable, and
the control unit controls each of the plurality of irradiation units to perform half-curing of the varnish applied to the first region by emitting UV rays while the first region is passing through an irradiation range thereof, and to perform full-curing of the varnish applied to the second region by irradiating the varnish applied to the second region by UV rays while the second region is passing through an irradiation range thereof, under different irradiation conditions from while the first region is passing therethrough.

13. The sheet embellishing system according to claim 8, further comprising:
a transfer device that subjects varnish that is applied to the second region and half-cured to predetermined transfer processing.

14. A non-transitory storage medium storing a machine-readable program, wherein
the program is read by a varnish-applying device that applies varnish that is ultraviolet (UV) curable to a sheet, and performs irradiation of the varnish by UV rays, and
realizes functions of controlling the varnish-applying device to apply varnish to a first region and a second region of the sheet,
perform half-curing of the varnish applied to the first region by irradiating the varnish applied to the first region by UV rays, and
perform full-curing of the varnish applied to the second region by irradiating the varnish applied to the second region by UV rays under different irradiation conditions from the varnish applied to the first region,
while the sheet is passed through the varnish-applying device once.
